(19) United States
(12) Patent Application Publication
(10) Pub. No.: US 2021/0179105 A1
(43) Pub. Date: Jun. 17, 2021

(54) VEHICLE AND METHOD OF CONTROLLING THE SAME

(71) Applicants: HYUNDAI MOTOR COMPANY, Seoul (KR); KIA MOTORS CORPORATION, Seoul (KR)

(72) Inventor: Donghyuk Kim, Hwaseong-si (KR)

(21) Appl. No.: 17/010,157

(22) Filed: Sep. 2, 2020

(30) Foreign Application Priority Data
Dec. 13, 2019 (KR) 10-2019-0167109

(51) Int. Cl. B60W 30/165; B60W 30/18; B60W 50/02; H04W 4/46

(52) U.S. Cl. CPC B60W 30/165; B60W 30/18163; B60W 50/0225; B60W 2050/0292; B60W 2050/0215; B60W 2050/021; H04W 4/46

(57) ABSTRACT

Provided are a vehicle and a method of controlling the same including a technology for towing an autonomous vehicle in the event of a sensor failure using another vehicle. The vehicle includes a detection sensor configured to detect an object around the vehicle to acquire at least one of position information or velocity information of the object, a communicator configured to communicate with a target vehicle located in front of the vehicle, and a controller configured to determine whether the detection sensor fails, control the communicator to transmit a vehicle towing request signal for towing the vehicle to the target vehicle upon determining that the detection sensor fails, and control the vehicle to travel by following the target vehicle upon receiving a vehicle tow confirmation signal of the vehicle from the target vehicle.

### CROSS REFERENCE TO RELATED APPLICATIONS

This application is based on and claims priority under 35 U.S.C. § 119 to Korean Patent Application No. 10-2019-0167109, filed on Dec. 13, 2019 in the Korean Intellectual Property Office, the disclosure of which is incorporated herein by reference.

### BACKGROUND

### 1. Field

The disclosure relates to a vehicle and a method of controlling the same, and more specifically, to a technology for towing an autonomous vehicle using another vehicle in the event of a sensor failure of the autonomous vehicle.

### 2. Description of the Related Art

In general, an autonomous vehicle (also referred to as an unmanned vehicle) refers to a vehicle capable of autonomous driving to a set destination by monitoring external information and identifying a road condition by itself without manipulation of a vehicle owner.

A control system of an autonomous vehicle, as a technology for recognizing lanes using a camera and performing automatic steering, measures a lane width, a lateral position of the vehicle on the lane, the distance to both lane lines, and the shape of the lane, the radius of curvature of the road on the basis of image processing of a camera, and by using the obtained information related to the position of the vehicle and the road, estimates a travelling trajectory of the vehicle and changes lanes according to the estimated travelling trajectory.

Such autonomous vehicles basically operate by following a map-based travelling path. However, when there are factors, such as obstacles, on the travelling path, the autonomous vehicle is controlled to change the travelling path in real time so that the vehicle safely travels. A vehicle control technology is suggested in which fully autonomous driving on a highway is achieved using sensors, motors, and artificial intelligence while excluding humans. The autonomous vehicles achieve fully autonomous driving by recognizing the surrounding environment in three dimensions using sensors and combining communication technology, artificial intelligence technology, and motor control technology.

The autonomous vehicles are frequently used to transport a large number of people, such as in buses and vans. The importance of safety of passengers during autonomous driving is emphasized when the number of people boarding the autonomous vehicle is large. In recent years, there is an increasing need for research on apparatuses and methods for ensuring the safety of passengers on board in response to driving paths and travelling situations of autonomous vehicles. In particular, a technology for stopping an autonomous vehicle in a safe area when normal autonomous driving is inoperable due to a failure of a sensor of the autonomous vehicle is considered an important issue.

### SUMMARY

Therefore, it is an object of the disclosure to provide a vehicle and a method of controlling the same, in which an autonomous vehicle is towed by another vehicle in the event of a sensor failure of the autonomous vehicle so as to be brought to a stop in a safe area, so that the safety of passengers are ensured.

Additional aspects of the disclosure will be set forth in part in the description which follows and, in part, will be obvious from the description, or may be learned by practice of the disclosure.

It is an aspect of the disclosure to provide a vehicle including a detection sensor configured to detect an object around the vehicle to acquire at least one of position information or velocity information of the object, a communicator configured to communicate with a target vehicle located in front of the vehicle, and a controller configured to determine whether the detection sensor fails, control the communicator to transmit a vehicle towing request signal for towing the vehicle to the target vehicle upon determining that the detection sensor fails, and control the vehicle to travel by following the target vehicle upon receiving a vehicle tow confirmation signal of the vehicle from the target vehicle.

The controller may control the communicator to transmit a traveling velocity reducing request signal to the target vehicle upon receiving the vehicle towing confirmation signal from the target vehicle.

The vehicle may further include a velocity adjuster configured to adjust a travelling velocity of the vehicle, wherein the controller may control the velocity adjuster such that the vehicle travels by following the target vehicle when a distance between the vehicle and the target vehicle is less than or equal to a predetermined distance as a result of a travelling velocity of the target vehicle being reduced.

The velocity adjuster may adjust the travelling velocity of the vehicle such that the distance between the vehicle and the target vehicle is maintained at the predetermined distance while the vehicle is travelling by following the target vehicle.

The communicator may transmit information regarding a towing end position of the vehicle to the target vehicle, and the controller may allow the vehicle to terminate travelling by following the target vehicle when the vehicle reaches the towing end position as a result of being towed by the target vehicle.

The communicator may receive a lane change signal from the target vehicle, and the controller may control the vehicle to change lanes along the target vehicle on a basis of the lane change signal.

It is another aspect of the disclosure to provide a method of controlling a vehicle including a detection sensor configured to detect an object around the vehicle to acquire at least one of position information or velocity information of the object, the method including determining whether the detection sensor fails, controlling a communicator to transmit a vehicle towing request signal for towing the vehicle to the target vehicle upon determining that the detection sensor fails, and controlling the vehicle to travel by following the target vehicle upon receiving a vehicle tow confirmation signal of the vehicle from the target vehicle.

The method may further include controlling the communicator to transmit a traveling velocity reducing request signal to the target vehicle upon receiving the vehicle towing confirmation signal from the target vehicle.

The method may further include adjusting a travelling velocity of the vehicle, wherein the adjusting of the travelling velocity of the vehicle may include adjusting the travelling velocity of the vehicle such that the vehicle travels by following the target vehicle when a distance between the vehicle and the target vehicle is less than or equal to a predetermined distance as a result of a travelling velocity of the target vehicle being reduced.

The adjusting of the travelling velocity of the vehicle may include adjusting the travelling velocity of the vehicle such that the distance between the vehicle and the target vehicle is maintained at the predetermined distance while the vehicle is travelling by following the target vehicle.

The method may further include transmitting information regarding a towing end position of the vehicle to the target vehicle, and allowing the vehicle to terminate travelling by following the target vehicle when the vehicle reaches the towing end position as a result of being towed by the target vehicle.

The method may further include: receiving a lane change signal from the target vehicle, and controlling the vehicle to change lanes along the target vehicle on a basis of the lane change signal.

### BRIEF DESCRIPTION OF THE FIGURES

These and/or other aspects of the disclosure will become apparent and more readily appreciated from the following description of the embodiments, taken in conjunction with the accompanying drawings of which:

FIG. 1 is an exterior view illustrating a general autonomous travelling bus;

FIG. 2 is a control block diagram illustrating a vehicle according to an embodiment;

FIG. 3 is a flowchart showing a method of controlling a vehicle according to an embodiment; and

FIGS. 4, 5, 6, and 7 illustrate another vehicle towing an autonomous vehicle to a safe area at a request of the autonomous vehicle according to an embodiment.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements,

Although the terms “first,” “second,” “A,” “B,” etc. may be used to describe various components, the terms do not limit the corresponding components, but are used only for the purpose of distinguishing one component from another component.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the principles and embodiments of the disclosure will be described with reference to the accompanying drawings.

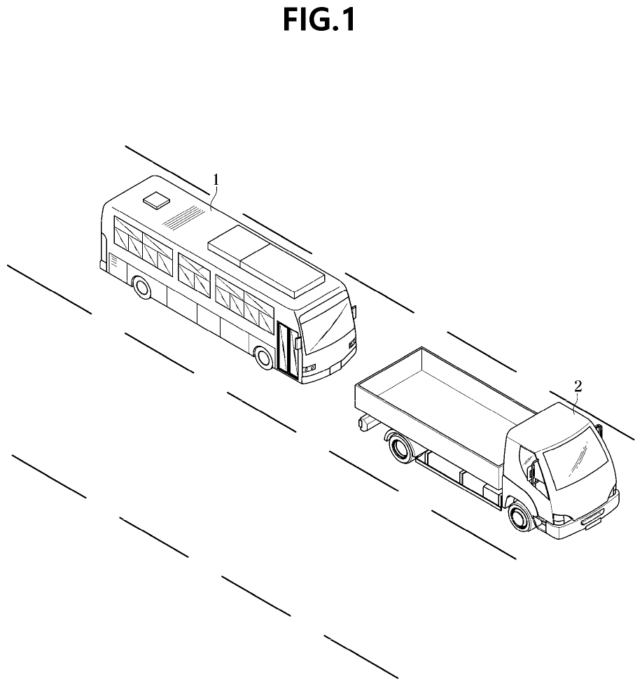

FIG. 1 is an exterior view illustrating a general autonomous travelling bus.

Referring to FIG. 1, a vehicle 1 and a method of controlling the vehicle 1 according to an embodiment of the disclosure will be described with reference to a bus 1. However, the vehicle according to an embodiment may be provided as other types of vehicles rather than a bus.

In addition, the vehicle 1 and the method of controlling the vehicle 1 according to the embodiment of the disclosure will be described with reference to an autonomous driving bus that travels to the destinations by itself without a driver's manipulation.

A control system of an autonomous vehicle, as a technology for recognizing lanes using a camera and performing automatic steering, measures a lane width, a lateral position of the vehicle on the lane, the distance to both lane lines, and the shape of the lane, the radius of curvature of the road on the basis of image processing of a camera, and by using the obtained information regarding the position of the vehicle and the road, estimates a traveling travelling trajectory of the vehicle and changes lanes according to the estimated travelling trajectory.

In the conventional technology, when autonomous driving of autonomous vehicles is not performable, the autonomous vehicle is controlled to stop in a safe area through the shortest distance travelling and the minimum change of lanes.

However, when the autonomous vehicle is unable to change lanes through autonomous driving due to a sensor failure, etc., the autonomous vehicle has difficulty in stopping in a safe area by itself.

According to the vehicle 1 and the method of the vehicle 1 according to the disclosed embodiment, when the autonomous vehicle is unable to stop in a safe area by itself through autonomous driving due to a sensor failure or the like, the autonomous vehicle transmits an autonomous vehicle towing request signal to another vehicle and travels by following the other vehicle, to thereby travel to a safe area and stop.

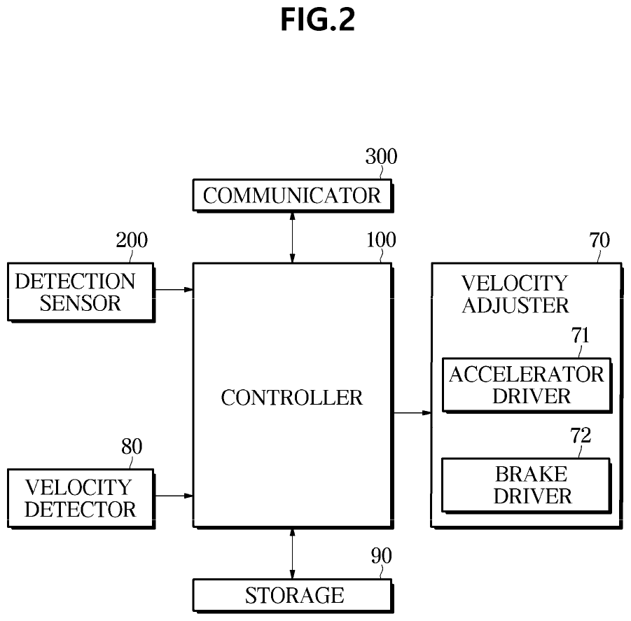

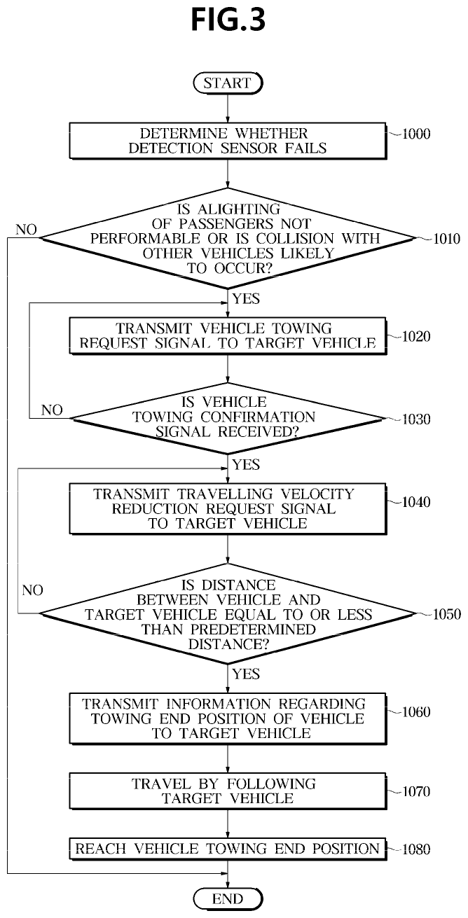

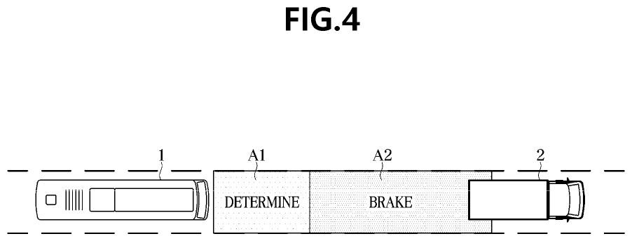

FIG. 2 is a control block diagram illustrating a vehicle according to an embodiment. FIG. 3 is a flowchart showing a method of controlling a vehicle according to an embodiment. FIGS. 4 to 7 illustrate another vehicle towing an autonomous vehicle to a safe area at a request of the autonomous vehicle according to an embodiment.

Referring to FIG. 2, the bus 1 according to the embodiment includes a velocity adjuster 70, a velocity detector 80, a storage 90, a controller 100, a detection sensor 200, and a communicator 300.

The velocity adjuster 70 may adjust the velocity of the bus 1 that is driven by a driver. The velocity adjuster 70 may include an accelerator driver 71 and a brake driver 72.

The accelerator driver 71 receives a control signal of the controller 100 to drive an accelerator to increase the velocity of the bus 1, and the brake driver 72 receives a control signal of the controller 100 to drive a brake to decrease the velocity of the bus 1.

That is, the controller 100 may calculate an estimated time of collision between the bus 1 and an object based on a relative distance and a relative velocity of the bus 1 and the object, and may transmit a signal for controlling the traveling speed of the bus 1 based on the calculated estimated collision time to the velocity adjuster 70.

The velocity adjuster 70 may adjust the travelling velocity of the bus 1 under the control of the controller 100. When there is a high chance of collision between the bus 1 and other objects, the velocity adjuster 70 may reduce the travelling velocity of the bus 1.

The velocity detector 80 may detect the travelling velocity of the bus 1 under the control of the controller 100. That is, the travelling velocity may be detected using the velocity at which the wheels of the bus 1 rotate, or the like. The unit of travelling velocity may be expressed in kph, that is, the distance (km) traveled per unit time (h).

The storage 90 may store various pieces of data related to the control of the bus 1. Specifically, in the vehicle and the method of controlling the vehicle according to the embodiment, the storage 90 may store data related to a driving path of the bus 1 for autonomous driving, and may store destination information for stopping the bus 1 in a safe area on the driving path when the bus 1 is unable to perform autonomous driving due to a failure of a detection sensor or the like.

The storage 90 may include a nonvolatile memory device, such as a cache, a read only memory (ROM), a programmable ROM (PROM), an erasable programmable ROM (EPROM), an electrically erasable programmable ROM (EEPROM), and a flash memory, a volatile memory device, such as a random access memory (RAM), or other storage media, such as a hard disk drive (HDD), a CD-ROM, and the like, but the implementation of the storage 90 is not limited thereto. The storage 90 may be a memory implemented as a chip separated from the processor, which has been described below in connection with the controller 100, or may be implemented as a single chip integrated with the processor.

The controller 100 may be provided in at least one unit thereof in the bus 1. The controller 100 may perform electronic control on each configuration related to the operation of the bus 1.

The functions performed by the controller 100 will be described in detail through the vehicle and the method of controlling the same according to the embodiment of the disclosure to be described below.

The communicator 300 may transmit data related to the travelling of the bus 1 to other vehicles around the bus 1 by communicating with the other vehicles, and receive data related to the travelling of the other vehicles from the other vehicles.

The communicator 300 may be implemented using a communication chip, an antenna, and related components to access a wireless communication network. That is, the communicator 300 may be implemented as various types of communication modules that can perform short-range communication or long-distance communication with other vehicles around the bus 1. That is, the communicator 300 may include a wireless communication module that transmits and receives data to and from other vehicles in a wireless manner.

The bus 1 may be provided with the detection sensor 200 that detects an object located in front of the bus 1 and acquires at least one of position information and travelling velocity information of the detected object.

The detection sensor 200 according to the embodiment may acquire at least one of position information and velocity information related to an object located around the bus 1. That is, the detection sensor 200 may acquire coordinate information of the object which is changed in real time as the object moves, and detect a distance between the bus 1 and the object.

The controller 100 may calculate the relative distance and the relative velocity of the bus 1 and the object using the position information and the velocity information of the object acquired by the detection sensor 200, and based on the relative distance and the relative velocity of the bus 1 and the object, calculate a time to collision (TTC) between the bus 1 and the object.

The detection sensor 200 may be mounted at a position suitable for recognizing an object (e.g., another vehicle) located on the front side, the lateral sides, or the front-lateral sides. According to the embodiment, the detection sensor 200 may be mounted on the front side, the left side, and the right side of the bus 1 to recognize all objects located in a forward direction thereof, a direction between the left side and the front side (hereinafter, referred to as a left front side), and a direction between the right side and the front side (hereinafter, referred to as a right front side) of the bus 1.

The detection sensor 200 may be implemented using a radar using millimeter waves or microwaves, a light detection and ranging (LiDAR) using a pulse laser beam, a vision sensor using visible light, an infrared sensor using infrared rays, an ultrasonic sensor using ultrasonic waves, or the like.

The bus 1 may perform autonomous driving based on the detection result of the detection sensor 200. On the other hand, when the detection sensor 200 fails, normal autonomous driving of the bus 1 is not performable, so that the safety of passengers in the bus 1 may not be secured and operation of other vehicles travelling around the bus 1 may be disturbed.

Referring to FIG. 3, the controller 100 may determine whether the detection sensor 200 provided on the bus 1 fails at 1000. That is, the controller 100 may determine whether the operation of the detection sensor 200 is normally performed based on a recognition result of a surrounding object obtained from the detection sensor 200 and a normality/abnormality of a signal received from the detection sensor 200.

When it is determined that the sensor 200 fails, the controller 100 may determine that autonomous driving of the bus 1 is not performable. When the autonomous driving of the bus 1 is not performable, the bus 1 is unable to travel to a safe area and stop by itself, so the bus 1 needs to be controlled to stop immediately. In this case, when the current position of the bus 1 is in the middle of the road being travelled on by the bus 1, passengers of the bus 1 may not get off the bus 1, and when the bus 1 stops in the middle of the road, there is a risk of collision with other vehicles on the road.

Therefore, as shown in FIG. 4, when it is determined that the detection sensor 200 fails, the controller 100 determines whether the bus 1 is in a situation that the passengers are unable to get off the bus 1 or there is a chance of collision between the bus 1 and other vehicles, based on the current position of the bus 1 at 1010.

That is, as illustrated in FIG. 4, when the detection sensor 200 of the bus 1 fails during autonomous driving, the controller 100 may determine whether the detection sensor 200 fails, whether the bus 1 is in a situation that passengers are unable to get off the bus 1, and there is a risk of collision with other vehicles while the bus 1 is travelling a predetermined distance A1.

When it is determined as a result of the determination that passengers are unable to get off the bus 1 or there is a risk of collision between the bus 1 and other vehicles, the controller 100 controls the communicator 300 to transmit, to a target vehicle 2 located in front of the bus 1, a bus towing request signal for towing the bus 1 at 1020.

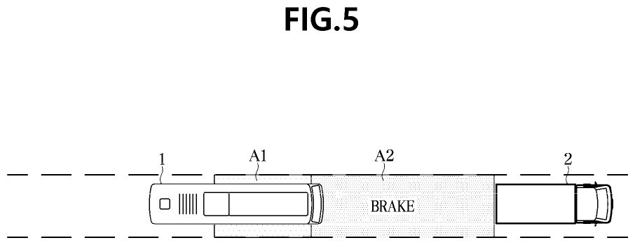

That is, as illustrated in FIG. 5, upon determining that the detection sensor 200 of the bus 1 fails, the bus 1 may transmit a bus towing request signal to the target vehicle 2 while the bus 1 is travelling.

The target vehicle 2, upon receiving the bus towing request signal from the bus 1, determines whether a bus towing travel mode for the bus 1 is performable and transmits a confirmation signal to the bus 1 about whether the towing of the bus 1 is performable. That is, the target vehicle 2, when the towing of the bus 1 is performable, may be switched to the bus towing travel mode for the bus 1, and when the towing of the bus 1 is not performable, and may transmit a response signal regarding the inoperability to tow the bus 1 to the bus 1.

The controller 100 may determine whether the communicator 300 has received the towing confirmation signal of the bus 1 from the target vehicle 2 at 1030. When it is determined as a result of the determination that the towing confirmation signal of the bus 1 has not received from the target vehicle 2, the controller 100 may transmit a bus towing request signal for towing the bus 1 to another target vehicle.

When it is determined as a result of the determination that the towing confirmation signal of the bus 1 has received from the target vehicle 2, the controller 100 may transmit a travelling velocity reduction request signal to the target vehicle 2 through the communicator 300 at 1040.

That is, in order that the bus 1 is towed by the target vehicle 2, the distance between the bus 1 and the target vehicle 2 needs to be within a certain distance, so that the bus 1 follows the target vehicle 2 and travels in a cluster travelling manner. Accordingly, the controller 100 may control the distance between the bus 1 and the target vehicle 2 to be within a certain distance by transmitting a request to reduce the travelling velocity of the target vehicle 2 to the target vehicle 2.

In addition to transmitting the travelling velocity reducing request signal to the target vehicle 2, the bus 1 may perform braking of the bus 1 to reduce the travelling speed thereof by controlling the velocity adjuster 70 of the bus 1 in a braking area A2 leading to the target vehicle 2 as shown in FIG. 5.

As the target vehicle 2 reduces the travelling velocity according to the travelling velocity reducing request received from the bus 1 and the bus 1 also performs braking in the braking area A2, the bus 1 and the target vehicle 2 become closer to each other, and the controller 100 may determine whether the distance between the bus 1 and the target vehicle 2 is equal to or less than a predetermined distance at 1050.

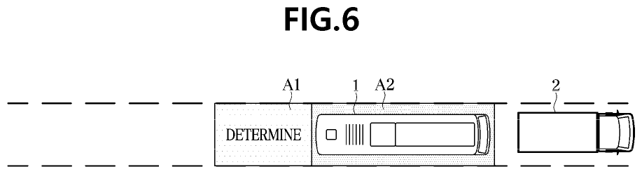

When it is determined as a result of the determination that the distance between the bus 1 and the target vehicle 2 is equal to or less than the predetermined distance as shown in FIG. 6, the controller 100 may determine that the target vehicle 2 is prepared to tow the bus 1.

When the preparation of towing the bus 1 of the target vehicle 2 is completed, the controller 100 may transmit information regarding a towing end position D of the bus 1 to the target vehicle 2 through the communicator 300 at 1060.

That is, when it is determined that the detection sensor 200 of the bus 1 fails, the controller 100 may generate and store information about a travelling path in which the bus 1 is towed by the target vehicle 1 and a towing end position D, and at the same time, may transmit the information to the target vehicle 2 through the communicator 300.

The target vehicle 2 may perform towing of the bus 1 based on the information regarding the travelling path and the towing end position D received from the bus 1, and the bus 1 may travel by following the target vehicle 2 at 1070.

When the towing of the bus 1 is started by the target vehicle 2, the controller 100 may control the bus 1 to travel by following the target vehicle 2 according to a cluster travelling method. In this case, the controller 100 controls the velocity adjuster 70 of the bus 1 so that the travelling velocity of the bus 1 is adjusted to maintain the distance between the bus 1 and the target vehicle 2 at a predetermined distance while the bus 1 is travelling by following the target vehicle 2.

The travelling of the bus 1 by following the target vehicle 2 may be achieved in a general cluster travelling method, and according to the cluster travelling method, the target vehicle 2 may tow the bus 1 such that the bus 1 reaches the towing end position D.

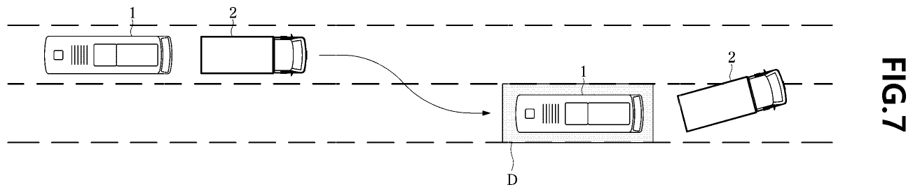

Referring to FIG. 7, the target vehicle 2 may tow the bus 1 based on the information regarding the travelling path and the towing end position D received from the bus 1, and the controller 100 may control the bus 1 to change lanes along the target vehicle 2 based on a lane change signal of the target vehicle 2 received by the communicator 300.

That is, when the detection sensor 200 of the bus 1 fails, autonomous driving is not performable, so the bus 1 may be unable to change lanes by itself. However, the bus 1 according to the disclosure travels by following the target vehicle 2 according to the towing of the target vehicle 2, so that the bus 1 may also change lanes based on a lane change signal of the target vehicle 2.

When the bus 1 reaches the predetermined towing end position D as the target vehicle 2 tows the bus 1 and the bus 1 travels by following the target vehicle 2 at 1080, the towing of the bus 1 of the target vehicle 2 is terminated.

As such, in the event of a failure of the detection sensor 200 of the bus 1 during autonomous driving, the bus 1 is towed by the target vehicle 2 and thus brought to a stop in a safe area so that the safety of passenger in the bus 1 is secured and other vehicles travelling around the bus 1 are prevented from being disturbed during travel.

Meanwhile, the disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which may be decoded by a computer are stored, for example, a Read Only Memory (ROM), a Random Access Memory (RAM), a magnetic tape, a magnetic disk, a flash memory, an optical data storage device, and the like.

As is apparent from the above, an autonomous vehicle is towed by another vehicle in the event of a sensor failure of the autonomous vehicle, so as to be brought to a stop in a safe area, so that the safety of passengers can be ensured and interference with other travelling vehicles around the autonomous vehicle can be prevented.

Although exemplary embodiments of the disclosure have been described for illustrative purposes, those skilled in the art will appreciate that various modifications, additions and substitutions are possible, without departing from the scope and spirit of the disclosure. Therefore, exemplary embodiments of the disclosure have not been described for limiting purposes.

1. A vehicle comprising:
a detection sensor configured to detect an object around the vehicle to acquire at least one of position information or velocity information of the object;
a communicator configured to communicate with a target vehicle located in front of the vehicle; and
a controller configured to determine whether the detection sensor fails, control the communicator to transmit a vehicle towing request signal for towing the vehicle to the target vehicle upon determining that the detection sensor fails, and control the vehicle to travel by following the target vehicle upon receiving a vehicle tow confirmation signal of the vehicle from the target vehicle.

2. The vehicle of claim 1, wherein the controller controls the communicator to transmit a travelling velocity reducing request signal to the target vehicle upon receiving the vehicle towing confirmation signal from the target vehicle.

3. The vehicle of claim 2, further comprising a velocity adjuster configured to adjust a travelling velocity of the vehicle, wherein the controller controls the velocity adjuster so that the vehicle travels by following the target vehicle when a distance between the vehicle and the target vehicle is less than or equal to a predetermined distance as a result of a travelling velocity of the target vehicle being reduced.

4. The vehicle of claim 3, wherein the velocity adjuster adjusts the travelling velocity of the vehicle such that the distance between the vehicle and the target vehicle is maintained at the predetermined distance while the vehicle is travelling by following the target vehicle.

5. The vehicle of claim 1, wherein the communicator transmits information regarding a towing end position of the vehicle to the target vehicle, and wherein the controller allows the vehicle to terminate travel by following the target vehicle when the vehicle reaches the towing end position as a result of being towed by the target vehicle.

6. The vehicle of claim 1, wherein the communicator receives a lane change signal from the target vehicle, and the controller controls the vehicle to change lanes with the target vehicle based on the lane change signal.

7. A method of controlling a vehicle including a detection sensor configured to detect an object around the vehicle to acquire at least one of position information or velocity information of the object, the method comprising:
determining by a controller whether the detection sensor fails;
controlling a communicator to transmit a vehicle towing request signal for towing the vehicle to a target vehicle upon determining that the detection sensor fails; and
controlling the vehicle to travel by following the target vehicle upon receiving a vehicle tow confirmation signal of the vehicle from the target vehicle.

8. The method of claim 7, further comprising controlling the communicator to transmit a travelling velocity reducing request signal to the target vehicle upon receiving the vehicle towing confirmation signal from the target vehicle.

9. The method of claim 8, further comprising adjusting a travelling velocity of the vehicle, which includes adjusting the travelling velocity of the vehicle so that the vehicle travels by following the target vehicle when a distance between the vehicle and the target vehicle is less than or equal to a predetermined distance as a result of a travelling velocity of the target vehicle being reduced.

10. The method of claim 9, wherein the adjusting of the travelling velocity of the vehicle includes adjusting the travelling velocity of the vehicle so that the distance between the vehicle and the target vehicle is maintained at the predetermined distance while the vehicle is travelling by following the target vehicle.

11. The method of claim 7, further comprising:
transmitting information regarding a towing end position of the vehicle to the target vehicle; and
allowing the vehicle to terminate travel by following the target vehicle when the vehicle reaches the towing end position as a result of being towed by the target vehicle.

12. The method of claim 7, further comprising:
receiving a lane change signal from the target vehicle, and
controlling the vehicle to change lanes with the target vehicle on a basis of the lane change signal.
